(19) United States
(12) Patent Application Publication
(10) Pub. No.: US 2024/0408492 A1
(43) Pub. Date: Dec. 12, 2024

(54) METHOD, APPARATUS, ELECTRONIC DEVICE, AND STORAGE MEDIUM FOR CONTROLLING A VIRTUAL OBJECT

(71) Applicant: Tencent Technology (Shenzhen) Company Limited, Shenzhen (CN)

(72) Inventors: Xing LIU, Shenzhen (CN); Zhangshu LIU, Shenzhen (CN)

(21) Appl. No.: 18/809,647

(22) Filed: Aug. 20, 2024

Related U.S. Application Data
(63) Continuation of application No. PCT/CN2023/012848, filed on Nov. 6, 2023.

(30) Foreign Application Priority Data
Nov. 22, 2022 (CN) 2022114666046

(51) Int. Cl. A63F 13/56; A63F 13/355

(52) U.S. Cl. CPC A63F 13/56; A63F 13/355

(57) ABSTRACT

One or more aspects of this application disclose a method, an apparatus, and a storage medium for controlling a virtual object. The method includes obtaining first operation information generated by a user for a first virtual object during a running of game on a cloud server, determining a first operation mode based on the first operation information, controlling the second virtual object based on the first operation mode, obtaining second operation information generated by the user for the first virtual object during the running of the game on the cloud server, determining a second operation mode based on the second operation information, and adjusting the first operation mode corresponding to the second virtual object to the second operation mode.

### RELATED APPLICATION

This application is a continuation application of PCT Application PCT/CN2023/129848, filed Nov. 6, 2023, which claims priority to Chinese Patent Application No. 202211466604.6 filed on Nov. 22, 2022, each entitled “METHOD AND APPARATUS FOR CONTROLLING VIRTUAL OBJECT, STORAGE MEDIUM, AND ELECTRONIC DEVICE”, and each which is incorporated herein by reference in its entirety.

### FIELD

This application relates to the field of computer technologies, and specifically, to a method, apparatus, storage medium, and electronic device for controlling a virtual object.

### BACKGROUND

In a cloud gaming scene, a virtual object controlled by a user (also referred to as a “game player”) performs interaction with a virtual object controlled by artificial intelligence, to achieve an objective of obtaining experience, a material, or a clearance reward. When players of different game levels exist, strength of artificial intelligence is usually adjusted by simply adjusting a value of the virtual object controlled by artificial intelligence in the related art, to avoid a significant gap between the strength of artificial intelligence and a level of the player.

However, when a same player shows different game levels during a game, the foregoing adjustment manner cannot flexibly adjust the value of the virtual object controlled by artificial intelligence based on the game level of the player. Therefore, there is a problem of low flexibility in controlling the virtual object in the related art.

Currently, there is no effective solution to resolve the foregoing problem.

### SUMMARY

One or more aspects of this application provide a method, apparatus, storage medium, and electronic device for controlling a virtual object, to at least resolve a technical problem of low efficiency in controlling the virtual object.

According to one aspect of the one or more aspects of this application, a method for controlling a virtual object is provided, including:
causing to be displayed, by a terminal device and during running of a game on a cloud server, a first virtual object of the game and a second virtual object of the game, the first virtual object being controlled by a user of the terminal device, and the second virtual object being controlled by artificial intelligence;
obtaining first operation information generated by the user for the first virtual object during the running of the game on the cloud server;
determining a first operation mode corresponding to the second virtual object based on the first operation information;
controlling the second virtual object based on the first operation mode;
obtaining second operation information generated by the user for the first virtual object during the running of the game on the cloud server, the first operation information being different from the second operation information;
determining a second operation mode corresponding to the second virtual object based on the second operation information, the first operation mode being different from the second operation mode;
adjusting, the first operation mode corresponding to the second virtual object to the second operation mode.

According to another aspect of the one or more aspects of this application, an apparatus for controlling a virtual object is further provided, including one or more processors and memory storing instructions that when executed by the one or more processors, causes the apparatus to:
cause to be displayed, during running of a game on a cloud server, a first virtual object of the game and a second virtual object of the game, the first virtual object being controlled by a user, and the second virtual object being controlled by artificial intelligence;
obtain first operation information generated by the user for the first virtual object during the running of the game on the cloud server;
determine a first operation mode corresponding to the second virtual object based on the first operation information;
control the second virtual object based on the first operation mode;
obtain second operation information generated by the user for the first virtual object during the running of the game on the cloud server, the first operation information being different from the second operation information;
determine a second operation mode corresponding to the second virtual object based on the second operation information, the first operation mode being different from the second operation mode; and
adjust, the first operation mode corresponding to the second virtual object to the second operation mode.

According to still another aspect of the one or more aspects of this application, a computer program product or a computer program is provided, including computer instructions, the computer instructions being stored in a computer-readable storage medium. A processor of a computer device reads the computer instructions from the computer-readable storage medium, and executes the computer instructions, to enable the computer device to perform the method for controlling a virtual object as described above.

According to still another aspect of the one or more aspects of this application, an electronic device is further provided, including a memory, a processor, and a computer program stored on the memory and executable on the processor, the processor performing the method for controlling a virtual object by using the computer program.

In the one or more aspects of this application, real-time acquisition of operation information is implemented by using a cloud game, an operation mode corresponding to a virtual object controlled by artificial intelligence is determined based on the acquired operation information, and the operation mode corresponding to the virtual object controlled by artificial intelligence is flexibly adjusted based on a real-time change of the operation information during the cloud game, to achieve an objective of updating the operation mode of artificial intelligence based on a real-time game level of a user. In this way, a technical effect of improving flexibility in controlling the virtual object is achieved, so that a technical problem of low flexibility in controlling the virtual object is resolved.

### BRIEF DESCRIPTION OF THE DRAWINGS

The accompanying drawings described herein are used to provide a further understanding of one or more aspects described herein, wherein:

FIG. 1 is a schematic diagram of an application environment of a method for controlling a virtual object.

FIG. 2 is a schematic flowchart of one or more aspects of an example of a method for controlling a virtual object.

FIG. 3 is a schematic diagram of one or more aspects of an example of a method for controlling a virtual object.

FIG. 4 is a schematic diagram of one or more aspects of an example of a method for controlling a virtual object.

FIG. 5 is a schematic diagram of one or more aspects of an example of a method for controlling a virtual object.

FIG. 6 is a schematic diagram of one or more aspects of an example of a method for controlling a virtual object n.

FIG. 7 is a schematic diagram of one or more aspects of an example of a method for controlling a virtual object.

FIG. 8 is a schematic diagram of one or more aspects of an example of a method for controlling a virtual object.

FIG. 9 is a schematic diagram of one or more aspects of an example of a method for controlling a virtual object.

FIG. 10 is a schematic diagram of one or more aspects of an example of a method for controlling a virtual object.

FIG. 11 is a schematic diagram of an example of an apparatus for controlling a virtual object.

FIG. 12 is a schematic structural diagram of an example of an electronic device for controlling a virtual object.

### DETAILED DESCRIPTION

The following describes the technical solutions of one or more aspects of this application with reference to the accompanying drawings All other aspects obtained by a person of ordinary skill in the art based on the one or more aspects of this application without creative efforts shall fall within the protection scope of this application.

Terms such as “first” and “second” in the specification, claims, and accompanying drawings are intended to distinguish between similar object rather than describe a particular sequence or a chronological order. The one or more aspects of this application described herein can be implemented in an order different from the order shown or described herein. In addition, terms “include”, “comprise”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

The following explains terms involved in the one or more aspects of this application.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, artificial intelligence is a comprehensive technology in computer science, and attempts to understand the essence of intelligence and produce a new intelligent machine that can react in a manner similar to human intelligence. Artificial intelligence is to study design principles and implementation methods of various intelligent machines, to enable the machines to have functions of perception, reasoning, and decision-making.

The artificial intelligence technology is a comprehensive discipline, and relates to a wide range of fields, including both hardware-level technologies and software-level technologies. Basic artificial intelligence technologies generally include technologies such as a sensor, a dedicated artificial intelligence chip, cloud computing, distributed storage, a big data processing technology, an operating/interaction system, and electromechanical integration. Artificial intelligence software technologies mainly include several major directions such as a computer vision technology, a speech processing technology, a natural language processing technology, and machine learning/deep learning.

With research and advancement of the artificial intelligence technology, the artificial intelligence technology is researched and applied in a plurality of fields, such as smart homes, smart wearing devices, virtual assistants, smart speakers, smart marketing, unmanned driving, autonomous driving, drones, robots, smart medicine, and smart customer services. It is believed that as the technology develops, the artificial intelligence technology will be applied in more fields, and play an increasingly important role.

Cloud gaming (also referred to as gaming on demand) is an online gaming technology based on a cloud computing technology. The cloud gaming technology enables a thin client with limited graphics processing and data operation capabilities to run a high-quality game. In a cloud gaming scene, a game is not run on a game terminal of a player, but is run on a cloud server, and the cloud server renders a game scene into video and audio streams and transmits the video and audio streams to the game terminal of the player through a network. The game terminal of the player does not need to have strong graphics operation and data processing capabilities, but only needs to have a basic streaming playback capability and a capability of obtaining an instruction inputted by the player and transmitting the instruction to the cloud server.

The solutions provided in the one or more aspects of this application involve technologies such as image recognition of artificial intelligence and cloud gaming, which are described below.

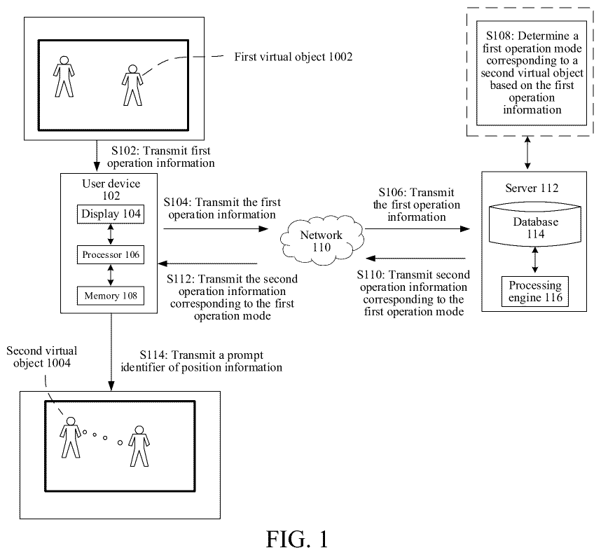

A method for controlling a virtual object is provided. In one example, the method for controlling a virtual object may be applied to an environment shown in FIG. 1, but is not limited thereto. The environment may include, but is not limited to, a user device 102 and a server 112. The user device 102 may include, but is not limited to, a display 104, a processor 106, and a memory 108. The server 112 may include a database 114 and a processing engine 116.

The method for controlling a virtual object may include the following operations:

Operation S102: The user device 102 obtains, from a client corresponding to a first virtual object 1002, first operation information of a user for the first virtual object.

Operations S104 to S106: The user device 102 transmits the first operation information of the user for the first virtual object to the server 112 through a network 110.

Operation S108: The server 112 determines a first operation mode corresponding to a second virtual object 1004 based on the first operation information through the processing engine.

Operations S110 to S112: The server 112 transmits second operation information of the first operation mode corresponding to the second virtual object 1004 to the user device 102 through the network 110; and the user device 102 processes the second operation information of the first operation mode through the processor 106, displays a process of controlling the second virtual object 1004 to cast a skill based on the second operation information of the first operation mode on the client, and stores the first operation information and the second operation information in the memory 108.

Operation S114: The user device 102 transmits a prompt identifier of position information to a device of the second virtual object 1004.

In addition to the example shown in FIG. 1, the foregoing operations may be independently completed by the client or the server, or jointly completed by the client and the server. For example, the user device 102 may perform the foregoing operations such as S108, thereby reducing processing pressure of the server 112. The user device 102 includes, but is not limited to, a handheld device (for example, a mobile phone), a notebook computer, a desktop computer, an in-vehicle device, or the like. The specific implementation of the user device 102 is not limited.

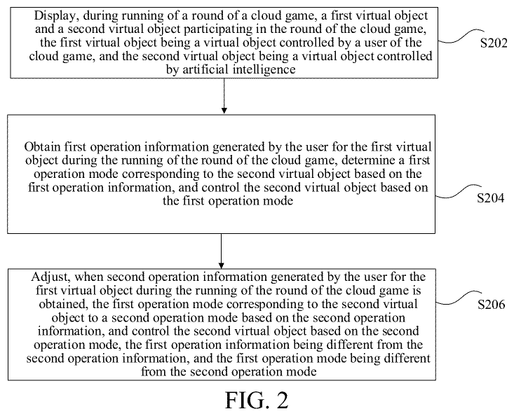

In another example, as shown in FIG. 2, the method for controlling a virtual object includes operations S202 to S206:

S202: Display, during running of a round of a cloud game, a first virtual object and a second virtual object participating in the round of the cloud game, the first virtual object being a virtual object controlled by a user of the cloud game, and the second virtual object being a virtual object controlled by artificial intelligence.

S204: Obtain first operation information generated by the user for the first virtual object during the running of the round of the cloud game, determine a first operation mode corresponding to the second virtual object based on the first operation information, and control the second virtual object based on the first operation mode.

S206: Adjust, when second operation information generated by the user for the first virtual object during the running of the round of the cloud game is obtained, the first operation mode corresponding to the second virtual object to a second operation mode based on the second operation information, and control the second virtual object based on the second operation mode, the first operation information being different from the second operation information, and the first operation mode being different from the second operation mode.

In this example, the method for controlling a virtual object may be applied in a cloud gaming scene, but is not limited thereto. The cloud game may be understood as follows: A game player inputs an instruction through a terminal device, and a cloud server may render, in real-time, game animation effects, graphic operations, and data processing. In this way, an operation requirement for the terminal device of the game player is greatly reduced. For a conventional game, a host of the terminal device of the game player is responsible for this part of work, and a terminal device with a large size, high costs, and high configuration is required to execute a large amount of computing power for the work. In a cloud gaming mode, because all graphics operations and game scene rendering are separated from local hardware, the terminal device of the game player may only need to perform displaying and encoding functions, and high power consumption and large storage space are not required (i.e., the power consumption and storage requirements of the terminal device are beneficially reduced). In the related art, during interaction between a virtual object controlled by the game player and a virtual object controlled by AI, AI strength is generally adjusted by simply adjusting a value of the virtual object controlled by AI. If the adjusted AI strength is too high or too low, both cases brings displeasure to the game player, greatly reducing fun of the game. As a result, there is a technical problem of low flexibility in adjusting the AI strength in the related art.

Here, the first virtual object may be understood as the virtual object controlled by the user (namely, a current game player), but is not limited thereto. For example, the user may control the virtual object to move, challenge, or cast a skill. The second virtual object may be understood as the virtual object controlled by artificial intelligence simulating a user, but is not limited thereto. The user herein refers to a human, to be specific, artificial intelligence simulates human thinking (specifically, thinking of a game player) to control the virtual object. A relationship between the first virtual object and the second virtual object may belong to a same camp or opposing camps in the game, but is not limited thereto. For example, the first virtual object controlled by the user and the second virtual object controlled by artificial intelligence simulating the user may be in a hostile relationship of different camps. A game backend may comprehensively evaluate a game level of the user based on factors such as an experience level, a historical winning rate, and an operation score of the user, and enable artificial intelligence to control the second virtual object to perform a corresponding operation based on the game level of the user, to achieve an objective of determining an operation mode simulated by artificial intelligence based on a comprehensive game level of the game player, thereby achieving a technical effect of improving accuracy of determining the operation mode.

In one instance, a game mode of the second virtual object may be determined in advance based on historical information, the experience level, and/or the like of the user, but is not limited to thereto. During the game, the first operation information generated by the user for the first virtual object may be obtained in real time. For example, the first operation information obtained in real-time may include whether the user completes a high-difficulty operation instruction (for example, reaching a preset difficulty threshold), an operation speed of the user, a quantity of challenges of the user, or a quantity of defeats of the user. The operation mode (also referred to as the operation mode of artificial intelligence) corresponding to the second virtual object controlled by artificial intelligence may be determined based on the first operation information. For example, if the user completes a high-difficulty operation at the start of the game, a level of artificial intelligence may be adjusted to a high-difficulty level based on the first operation information, and the difficulty level matches difficulty of a user operation, to achieve an objective of determining the operation mode of artificial intelligence based on the first operation information of the user, thereby generating moderate-difficulty AI, and bringing better game experience to the player.

The operation mode may be, but is not limited to, an operation mode determined by a difficulty level, such as an easy mode, a normal mode, or a challenge mode in the game; or may be an operation mode determined by a functional purpose of a game section, such as an entertainment mode or a formal mode in the game; or may be a different operation mode determined based on a gameplay of the game player. For example, in a game including gameplays such as collection and battles, if the player is more prone to the collection gameplay, the operation mode of AI may be adjusted to AI with a higher collection level (for example, reaching a preset level) based on the gameplay of the player. For example, in a shooting game, the user likes to collect skins of various props, but an adversarial shooting level may be poor. Artificial intelligence may obtain the gameplay of the user and adjust the operation mode corresponding to the virtual object controlled by artificial intelligence to an operation mode with a good costume effect but a poor adversarial level.

In the related art, the operation mode of AI is generally determined based on an experience value of the player, and the gameplay of the player is not considered. For example, a player A prefers to costume the virtual object, and does not like to operate the virtual object to attack. Even if an overall experience value of the player A is high, if an AI virtual object with a high adversarial mode is matched to the player, it is difficult for the player A to operate, reducing interest of the player. Alternatively, an AI virtual object with a low adversarial mode is determined based on a specific attack attribute of the player A, but that the player A prefers to costume the virtual object is not considered, resulting in a problem of low flexibility of the operation mode of AI. In one or aspects described herein, through obtaining of operation information that the player A likes to costume the virtual object, the operation mode of AI may be adjusted to an operation mode with more aesthetic costumes and skins and a low adversarial attribute, thereby achieving an objective of flexibly adjusting the operation mode of AI.

The second operation information may be understood as operation information having a low similarity with the first operation information. In other words, different from the first operation information, the second operation mode may be understood as an operation mode corresponding to the second operation information. Operation information may include, but is not limited to, information such as a quantity of operation instructions for the virtual object controlled by the user of the cloud game in each time period of a game process, whether a high-level operation is completed, and/or an operation speed at which the operation instruction is executed once, for example, a quantity of card draws, a quantity of challenges, and/or a quantity of purchases.

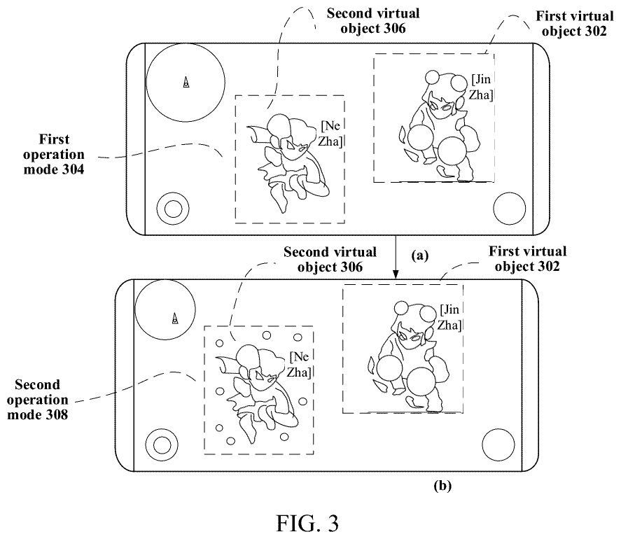

In one example, as shown in FIG. 3, a player A and a player B may jointly control the first virtual object to complete the round of the game. The player A may control a first virtual object 302 to complete first three minutes of the game process, and after the player A completes the first three minutes of the game process, the rest of the game process may be completed by the player B controlling the first virtual object 302. Because a game operation level of the player A is poor, after first operation information generated by the player A for the first virtual object 302 in the first three minutes of the game process is obtained, the game backend learns that the player A does not cast a set of combos. Therefore, a first operation mode 304 corresponding to a second virtual object 306 controlled by artificial intelligence may be determined as an easy operation mode, for example, as shown in (b) in FIG. 3. After three minutes, the player B may control the first virtual object 302 to complete the rest of the game process. Because a game operation level of the player B is high, the first operation mode 304 corresponding to the second virtual object 306 may adjusted to a second operation mode 308 based on second operation information that the player B successively completes a plurality of high-difficulty operations in a short time period, to be specific, the easy operation mode is adjusted to an expert operation mode, to achieve an objective of adjusting the operation mode of artificial intelligence based on a real-time game level of the user, thereby achieving a technical effect of improving flexibility in controlling the virtual object.

In the related art, adjustment of the operation mode of AI based on the operation level of the game player all occurs before the start of the game, but a fact that there may be a large change in the operation level of the game player for a same virtual object during the game is ignored. Therefore, there is a problem of low flexibility in controlling the virtual object in the related art. As described herein however, through obtaining of real-time operation information of the game player in the game, the operation mode corresponding to the second virtual object may be adjusted in real time. In addition, the process of the cloud game is run on a server side, so that images and operation instruction streams may be directly read from a video memory, and an intermediate process does not need to be performed, thereby greatly reducing a delay. In this way, real-time obtaining and real-time adjustment can be implemented, thereby achieving a technical effect of improving efficiency of controlling the virtual object.

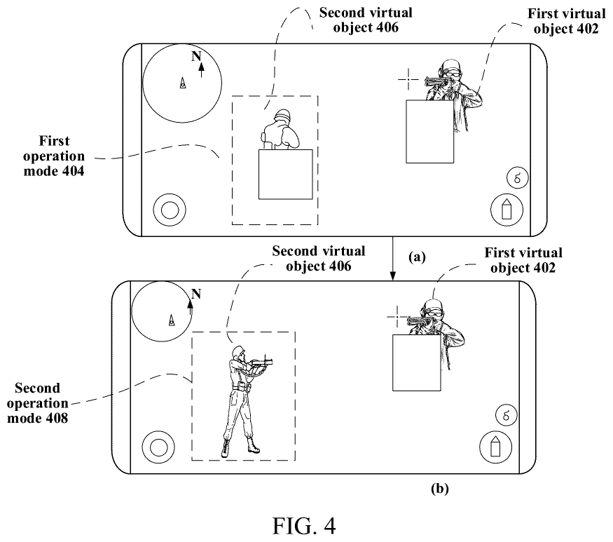

In a shooting game, although shooting accuracy is a main gameplay of the game, due to a large number of costumes for a virtual object and costumes for a virtual prop in the game, there is also a gameplay in which the player collects the costume or the skin. For example, as shown in (a) in FIG. 4, a second virtual object 406 with an average level may be matched in advance based on the level of the player. In this case, a first operation mode 404 corresponding to the second virtual object 406 may be a shooting mode. Because a player C is a player who likes to collect the costume but has a low shooting level, the operation mode corresponding to the second virtual object 406 may be adjusted by obtaining a costume attribute of a first virtual object 402 controlled by the player C. The costume attribute may include, but is not limited to, a quantity of skins, a rarity degree of the skin, or the like. Through obtaining of a costume of the first virtual object 402 with a high rarity degree (for example, reaching a preset rarity degree), for example, as shown in (b) in FIG. 4, the first operation mode 404 (for example, a normal costume mode) corresponding to the second virtual object 406 may be adjusted to a second operation mode 408 with a high aesthetic degree (for example, reaching a preset aesthetic degree), to attract the player to complete the shooting game, and achieve an objective of increasing interest of the player, thereby achieving a technical effect of improving diversity of controlling the virtual object.

In the one or more aspects of this application, real-time acquisition of operation information may be implemented in a cloud gaming scene, an operation mode of a virtual object controlled by artificial intelligence may be determined based on the operation information, and real-time adjustment of the operation mode of the virtual object controlled by artificial intelligence may be implemented based on a change of the operation information during the game, to achieve an objective of updating the game operation mode of artificial intelligence based on a real-time game operation level of a user. In this way, a technical effect of improving flexibility in controlling the virtual object is achieved, so that a technical problem of low flexibility in controlling the virtual object is resolved.

After the obtaining first operation information generated by the user for the first virtual object, the method may further include:
determining a start time point of the first operation mode;
obtaining, after the start time point, a plurality of pieces of operation information of the user for the first virtual object during the running of the round of the cloud game; and
determining the second operation information based on the plurality of pieces of operation information.

The start time point may be, but is not limited to, a specific moment during running of a round of a cloud game. After the first operation information generated by the user for the first virtual object is obtained, in this case, the operation mode corresponding to the second virtual object may be determined as the first operation mode based on the first operation information, and a start moment of the first operation mode may be further determined; the plurality of pieces of operation information of the user for the first virtual object during the running of the round of the cloud game may be obtained starting from the start moment of the first operation mode; and the second operation information may be determined based on operation information generated in a time period after the start moment of the first operation mode.

The first operation mode may be determined based on operation information of the player in a time period, rather than determining the first operation mode based on operation information of a whole round. The reason is that there may be a large difference in levels of the player in different time periods of a whole round of the game process. For example, there may be a case that the level of the player is poor at the start, but the level of the player is particularly high in a time period. If an average experience value of the player is simply taken, the operation mode cannot be accurately determined based on the operation information of the player. As a result, there is a technical problem of low accuracy of determining the operation mode.

After the first operation mode is determined based on the operation information of the player in the time period, operation information in a next time period may be obtained again, and may then again be used to adjust the operation mode. Compared with taking the average experience value of the player based on the operation information of the whole round of the game, through division of time periods, as described herein, a technical effect of improving accuracy of determining the operation mode is achieved.

The start time point of the first operation mode may be determined; the plurality of pieces of operation information of the user for the first virtual object during the running of the round of the cloud game after the start time point may be obtained; and the second operation information may be obtained based on the plurality of pieces of operation information, to achieve an objective of acquiring the operation information through division of the time periods, thereby achieving the technical effect of improving accuracy of determining the operation mode.

The determining the second operation information based on the plurality of pieces of operation information may include:
determining, from the plurality of pieces of operation information, first target operation information of which an information similarity with key operation information is higher than or equal to a first preset threshold; and
determining the first target operation information as the second operation information when a quantity of pieces of the first target operation information is greater than or equal to a second preset threshold.

The operation information may be understood as a set of a plurality of operations generated by the user for the first virtual object during the running of the round of the cloud game. In one example, the operation information may be formed by the key operation information and routine operation information. The key operation information may be a plurality of pieces of operation information with a specific difficulty or importance degree or a rarity degree, or the key operation information may be operation information formed by combining a plurality of pieces of routine operation information.

Information similarity comparison may be performed on a plurality of pieces of recognized operation information and preset key operation information. In addition, operation information of which a similarity with the key operation information is higher than or equal to the first preset threshold may be determined as the first target operation information. Considering that a key operation may also be accidentally triggered by the user, the quantity of pieces of the first target operation information may be obtained, and when the quantity of pieces of the first target operation information is greater or equal to the second preset threshold, the first target operation information may be determined as the second operation information.

Considering that the key operation information is the operation information with a specific difficulty or rarity degree, an ability of the user to complete the key operation also indirectly proves that the user has specific game experience or a high game level. However, if only a case of whether the key operation is completed is considered as a basis for determining the operation mode of AI, a problem of low accuracy may be caused. For example, the user accidentally triggers the key operation, but a comprehensive game level of the user is low. If the operation mode corresponding to the second virtual object is adjusted to a high-difficulty operation mode, this is not conducive to game experience of the user. Further, a quantity of pieces of the key operation information may be considered, thereby achieving a technical effect of accurately determining the second operation information by combining the key operation and a quantity of operations.

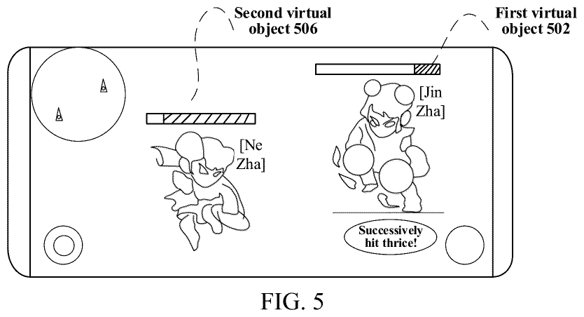

In the example shown in FIG. 5, a first virtual object 502 controlled by a player may successively cast a high-difficulty skill thrice in three minutes, and may cause damage of 300 health points to a second virtual object 504 controlled by artificial intelligence, to reach 80% of the damage. Acquired operation information corresponding to a damage value, the operation instruction, or the like may be inputted into a model, to obtain a result that the level of the player is high (for example, reaching the preset level) in this case. Therefore, an operation mode with a low difficulty level corresponding to the second virtual object 504 may be adjusted to an operation mode with a high difficulty level. A difficulty level may be determined by a preset difficulty threshold. If the difficulty level is lower than the difficulty threshold, the difficulty level may be low; and if the difficulty level is higher than the difficulty threshold, the difficulty level may be high.

The determining the second operation information based on the plurality of pieces of operation information may include:
inputting the plurality of pieces of operation information into a target model, the target model being a neural network model configured to recognize operation information of the user for the first virtual object obtained through training by using a plurality of pieces of sample operation information;
obtaining second target operation information outputted by the target model; and
determining the second target operation information as the second operation information when the second target operation information is different from the first operation information.

In this way, an objective of combining a key operation and a quantity of operations can be achieved, thereby achieving a technical effect of improving accuracy of determining the second operation information.

After the plurality of pieces of operation information are obtained, such as an operation instruction and a quantity of defeats of the player, a current game picture of the player may further be captured, and player information in the game picture, such as time information and a completion degree of a game task, may further be extracted. The operation information, based on environment information and the operation instruction extracted from the game picture, is inputted into the trained neural network model by using a processing means such as normalization and data integration to update the trained neural network model.

The second target operation information may be operation information outputted by the target model. Similarity comparison may be performed on the second target operation information and the first operation information, and if the similarity is higher than or equal to a preset threshold, the second target operation information may be determined as the second operation information. Alternatively, a plurality of levels may be set based on difficulty, gameplay, or the like of the game, to respectively calculate comprehensive data of the second target operation information and the first operation information. If levels indicated by the comprehensive data of the second target operation information and the first operation information are different, the second target operation information may be determined as the second operation information.

In the related art, simple adjustment on a parameter is used to determine the operation information or the operation mode. But as described herein, the operation information may be determined by using the trained neural network model, thereby improving accuracy of determining the operation information.

Before the inputting the plurality of pieces of operation information into a target model, the method may further include:
performing the following operations until the target model is obtained:
obtaining a current sample from the plurality of pieces of sample operation information, each sample operation information including a current environment parameter, a current action parameter, and a current sample result, the current environment parameter being a parameter related to an environment in which an operation corresponding to the sample operation information is performed, the current action parameter being an action type corresponding to the operation corresponding to the sample operation information, and the current sample result that corresponds to an operation performed by the second virtual object and matches the operation corresponding to the sample operation information;
inputting the current sample into an intermediate model, to obtain intermediate operation information outputted by the intermediate model;
determining, when an information similarity between the intermediate operation information and the current sample result is higher than or equal to a third preset threshold, that the intermediate model reaches a convergence condition, and determining the intermediate model as the target model; and
determining, when the information similarity between the intermediate operation information and the current sample result is lower than the third preset threshold, that the intermediate model does not reach the convergence condition, obtaining a next sample from the plurality of pieces of sample operation information, and determining the next sample as a current sample.

The intermediate model may be a model when the training of the neural network model is not completed. A training process of the target model may include, but is not limited to being understood as, acquisition of an environment parameter, an action parameter, and a result parameter of the player during the whole round of the game when players battle against each. The environment parameter may be understood as a parameter related to an environment in which an operation of the player is performed during the game. The environment parameter may include, but is not limited to, position information when the player is attacked, movement information when the player casts a skill, surrounding environment information when the player casts the skill, or the like. The action parameter may be understood as an action parameter corresponding to the operation of the player during the game. The action parameter may include, but is not limited to, a specific operation instruction for casting a high-difficulty skill once, an operation instruction for response when another operation instruction is received, or the like. The current sample result may be the information that corresponds to the operation performed by the second virtual object and matches the operation corresponding to the sample operation information. The current sample result may also or alternatively be an operation result when the players battle against each other.

When the environment parameter, the action parameter, and the result parameter are obtained, the current sample may be inputted into the intermediate model, to obtain the intermediate operation information outputted by the intermediate model; information similarity comparison may be performed on the intermediate operation information and the current sample result; it is determined that the intermediate model reaches the convergence condition when the information similarity is higher than or equal to the third preset threshold, and the intermediate model may be determined as the target model; and when the information similarity is lower than the third preset threshold, it is determined that the intermediate model does not reach the convergence condition, another sample information from the plurality of pieces of sample operation information is obtained, and the foregoing operations are performed on the another sample information for model training until the intermediate model reaches the convergence condition. Model training may be performed based on the environment parameter, the action parameter, and the sample result, thereby achieving a technical effect of improving accuracy of the model training.

Performance of the target model may be measured by using a loss function, but is not limited thereto. A distance between an actual “excitation value” and an “excitation value” generated by model prediction action may be used as the loss function, for example, as shown in the following Formula (1):

$$L = {\frac{1}{2} [ {\underbrace{{max}_{{a}^{′}} Q ( {s}^{′} , {a}^{′} )}}_{target} - {\underbrace{Q ( s , a )}}_{prediction} ]}^{2} \qquad ( 1 )$$

L is an abbreviation for LOSE, and represents a loss value. A calculation process of the loss function may be actually to calculate a mean square error. The

$$L = {\frac{1}{2} [ {\underbrace{{max}_{{a}^{′}} Q ( {s}^{′} , {a}^{′} )}}_{target} - {\underbrace{Q ( s , a )}}_{prediction} ]}^{2} \qquad ( 1 )$$

represents a target value. For example, in an adversarial game, the virtual object may lose 1 health point or 2 health points, but if it is intended to make performance of the model better, a maximum health point loss value is selected, which indicates a maximum damage value hit by the first virtual object controlled by the user. Output of the [symbol] represents a value hit by the second virtual object controlled by artificial intelligence. A difference between the foregoing two values are solved, and then the difference is squared and divided by 2, to obtain the loss value L. An objective of model training may be to make the loss value L equal to 0 or close to 0. If L is 0, it indicates that the model reaches a perfect state. In this case, the training of the model is completed, and the model is determined as the target model. During the model training, the distance between the actual excitation value and the excitation value generated by model prediction action may be used as the loss function, and a model parameter may be updated through back propagation, to generate a final target model.

Because an algorithm using nonlinear propagation to approximate a Q value may be unstable, and in many cases, it may be difficult for the model to converge, the model can quickly converge by using empirical playback. In a conventional client game, online acquisition of the operation information such as an image and the operation instruction generates a large bandwidth burden, affecting game experience of the player. However, because as described herein the cloud game may be on the server side, and acquisition of the operation information directly by using a resource of the server side does not generate additional bandwidth overheads, the acquisition costs may be low. In addition, a cloud gaming service cluster has sufficient GPU computing power, so that operation costs can be reduced by fully using a computing power resource of the server during the model training.

After the inputting the plurality of pieces of operation information into a target model, the method may further include:
performing, when the operation information is image information acquired during the running of the round of the cloud game, image recognition on the image information by using an image information recognition module in the target model, to obtain processed operation information; and
inputting the processed operation information into an operation information recognition module in the target model, to obtain the second target operation information.

An objective of obtaining the second target operation information may be achieved through image recognition and model training, thereby achieving a technical effect of improving accuracy of obtaining the operation information.

After the target model is generated, a real-time game picture of the player may be acquired by using an advantage of low image acquisition costs because the cloud game is run on the server side, and an operation instruction or an operation mode of artificial intelligence closest to an actual operation level of the player may be obtained through model operation.

Compared with running a game on a local client, both model training and image acquisition may be completed in the cloud, as described herein. Therefore, no additional delay caused by data interaction or instruction delivery occurs. For the player, a reaction of an opponent is more timely, game experience is better, and a model parameter may be updated online in real-time.

The obtaining first operation information generated by the user for the first virtual object during the running of the round of the cloud game, determining a first operation mode corresponding to the second virtual object based on the first operation information, and controlling the second virtual object based on the first operation mode may include:
obtaining the first operation information generated by the user for the first virtual object in a first time period during the running of the round of the cloud game, determining the first operation mode based on the first operation information, and controlling an action operation of the second virtual object after the first time period based on the first operation mode.

The controlling an action operation of the second virtual object based on the first operation mode may be understood as determining, based on the operation information generated by the user for the first virtual object, that an operation level corresponding to the first virtual object is a low difficulty level (for example, lower than the preset difficulty threshold), and setting the operation mode corresponding to the second virtual object to a low difficulty level, to control the second virtual object to execute an operation instruction of a moderate and low difficulty level after the first time period.

As a result, an objective of determining the operation mode based on the operation information in the time period may be achieved, thereby achieving a technical effect of improving diversity of the operation mode.

After the controlling an action operation of the second virtual object after the first time period based on the first operation mode, the method may further include:
obtaining the second operation information generated by the user for the first virtual object in a second time period after the first time period during the running of the round of the cloud game, determining the second operation mode based on the second operation information, and controlling an action operation of the second virtual object after the second time period based on the second operation mode.

As a result, an objective of flexibly controlling the second virtual object may be achieved, thereby achieving a technical effect of improving flexibility in controlling the virtual object.

The controlling the second virtual object based on the first operation mode may include:
controlling the second virtual object to execute at least one first operation instruction corresponding to the first operation mode; and
the controlling the second virtual object based on the second operation mode includes: controlling the second virtual object to execute at least one second operation instruction corresponding to the second operation mode.

The virtual object may be controlled to execute corresponding operation instructions based on different operation modes. For example, if it is determined, based on the operation information, that the player can complete a high-difficulty operation instruction, the operation instruction executed by the second virtual object may be adjusted to an operation instruction that is not easy to be cast. In this way, an objective of flexibly adjusting a specific operation instruction of the second virtual object based on the operation information of the player for the first virtual object is achieved, thereby achieving a technical effect of improving flexibility in controlling the virtual object.

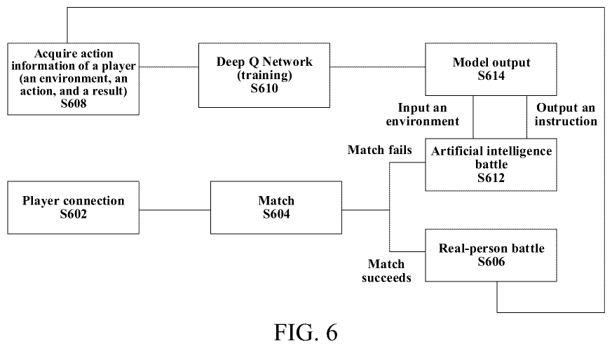

As shown in FIG. 6, the method for controlling a virtual object may include the following operations S602 to S614 when applied in an example scenario:

Operation S602: Detect whether a player enters game connection.

Operation S604: Match an opponent player based on basic information such as a level, experience, and/or a winning rate of the player.

Operation S606: Enter a real-person battle game scene if the match is successful, such that a first virtual object controlled by the player is enabled to battle a third virtual object controlled by the matched opponent player, to complete the game.

Operation S608: Periodically acquire operation information such as an action operation of the player by using real-time image information and an action result when the first virtual object controlled by the player plays the game with the third virtual object controlled by the opponent player (for example, acquire once every 32 ms, to capture a value from a real-time image, for example, a health point value), where the real-time image information includes a current position of the player and the action operation of the player, and the action result may include, but is not limited to, a health point loss value in the battle, or the like.

Operation S610: Input the operation information into a deep learning network model for training after the operation information is acquired.

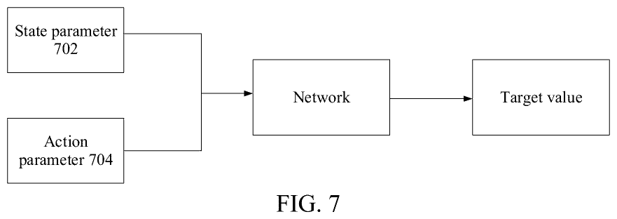

The deep learning network (Deep Q Network) model may be generated as shown in FIG. 7. A state parameter 702 may indicate an environment in which the player is currently in, for example, a two-person battle game scene or a position of the target of the first virtual object. An action parameter 704 may indicate an action operation taken by the first virtual object for the target, such as moving forward or giving a kick. Such two parameters may be inputted into the Deep Q Network, and the Deep Q Network may output a target value (Q-value). If the environment is the two-person battle game scene, and the health point loss value is used as the target, the Q-value may be used as a maximum health point loss value. If the environment is another game scene, a target with a different meaning may be defined.

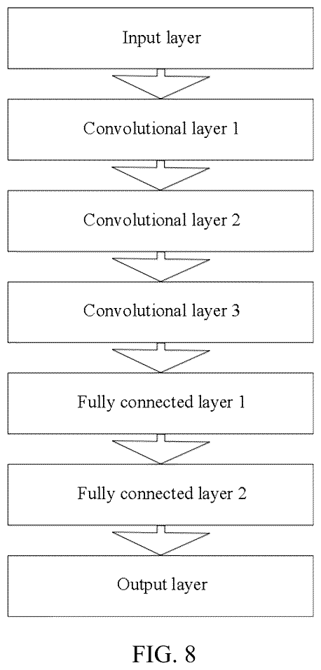

A neural network is a basis of the deep learning network. For example, a neural network model shown in FIG. 8 includes one input layer, three convolutional layers, two fully connected layers, and one output layer. A purpose of the convolutional layer is to extract information in the image for image recognition, for example, recognizing a position of the virtual object in the image, or capture some information from the image, for example, a maximum winning rate of the virtual object controlled by the player. An objective of training a neural network model may be that, when it is determined that the first virtual object is in a state, a second virtual object controlled by artificial intelligence simulating the player can use a policy corresponding to the state. Training of the neural network model may include setting an optimization target, so that the neural network model outputs a value meeting a requirement through training. Constructing the neural network model may include constructing a formula to adjust a parameter of the neural network model. For example, performance of the neural network model may be measured by using the loss function shown in the foregoing formula (1).

Referring back to FIG. 6, additional operations may include Operations S612-S614. Operations S612 to S614: Enter an artificial intelligence battle game scene if the match is not successful, acquire a real-time picture of the first virtual object controlled by the player, where acquisition may be performed on each frame of the image, and input acquired data into a trained neural network model for operation, to obtain an optimal reaction of the second virtual object controlled by artificial intelligence, such as an operation instruction or an operation mode of artificial intelligence. Compared with running a game on a local client, both model training and image acquisition may be completed in the cloud. Therefore, no additional delay caused by data interaction or instruction delivery occurs. For the player, a reaction of an opponent is more timely, game experience is better, an online real-time update can be performed on a model parameter, so that usage by the local client is beneficially reduced.

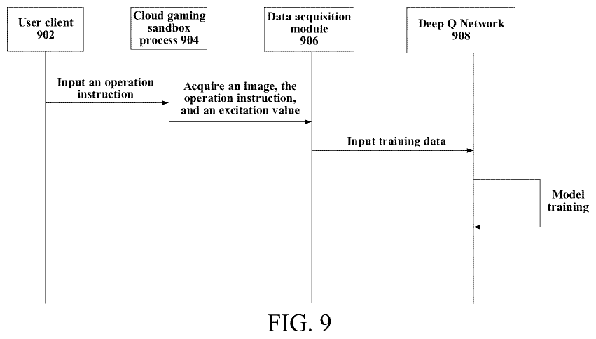

An example of a model training process is shown in a training timing diagram of FIG. 9. A user client 902 uploads an operation instruction inputted by the player to a cloud gaming sandbox process 904 in a server. A data acquisition module 906 captures a current image, the operation instruction of the player, and health point information after the operation from the cloud gaming sandbox process 904, to complete acquisition of the image, the operation instruction, and an excitation value, and inputs the image and the operation instruction into a Deep Q Network model 908 as input data, to train the Deep Q Network model 908 and to update the model parameter through back propagation.

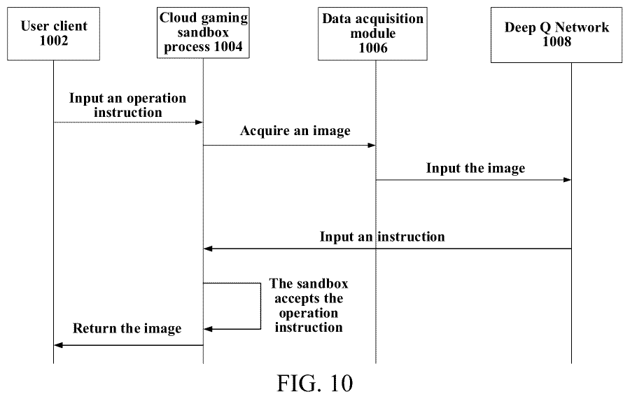

An example of a battle process between the player and artificial intelligence is shown in a timing diagram of FIG. 10. A user client 1002 inputs an operation instruction of the player into a cloud gaming sandbox process 1004. A data acquisition module 1006 performs image acquisition from the cloud gaming sandbox process 1004, extracts a current game picture and the operation instruction of the player, and inputs the extracted game picture and the operation instruction into a trained Deep Q Network model 1008. The Deep Q Network model 1008 returns an operation instruction of artificial intelligence to the cloud gaming sandbox process 1004. The cloud gaming sandbox process 1004 receives the returned operation instruction, inputs the operation instruction into a game process, to enable artificial intelligence to perform an operation based on the operation instruction, and returns a game battle picture to a cloud gaming server. The cloud gaming server returns the game battle picture to the user client 1002 for display.

The method described herein results in more accurate and optimized AI results because the AI results conform more to human thinking, to make the player feel that AI is an actual human player, thereby better attracting the player, and enhancing player experience. In addition, an AI matching mechanism may further be optimized, and a game level of the player may be more accurately evaluated, to match an opponent or a team friend of a similar level, and ensure that the game has the right level of difficulty, thereby allowing the player to have better game experience, and enjoying the competition.

In some instances, related data such as user information may be used. When the foregoing one or more aspects of this application are applied to specific products or technologies, user permission or consent needs to be obtained, and collection, use, and processing of the related data need to comply with relevant laws, regulations, and standards.

For convenience of description, the foregoing methods are represented as a series of operation combinations. However, a person skilled in the art would understand the methods are not limited to the described order of the operations because some operations may be performed in another order or performed simultaneously. Secondarily, a person skilled in the art would understand that all the one or more aspects described in this specification are exemplary, and related operations and modules are not necessary required in this application.

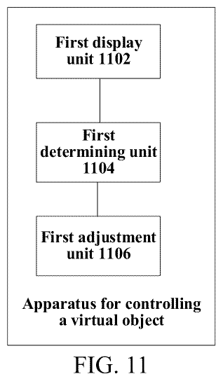

An apparatus for controlling a virtual object configured to implement the foregoing method for controlling a virtual object is further provided. As shown in FIG. 11, the apparatus may include:
a first display unit 1102, configured to display, during running of a round of a cloud game, a first virtual object and a second virtual object participating in the round of the cloud game, the first virtual object being a virtual object controlled by a user of the cloud game, and the second virtual object being a virtual object controlled by artificial intelligence;
a first determining unit 1104, configured to obtain first operation information generated by the user for the first virtual object during the running of the round of the cloud game, determine a first operation mode corresponding to the second virtual object based on the first operation information, and control the second virtual object based on the first operation mode; and
a first adjustment unit 1106, configured to adjust, when second operation information generated by the user for the first virtual object during the running of the round of the cloud game is obtained, the first operation mode corresponding to the second virtual object to a second operation mode based on the second operation information, and control the second virtual object based on the second operation mode, the first operation information being different from the second operation information, and the first operation mode being different from the second operation mode.

The apparatus may further include:
a second determining unit, configured to determine a start time point of the first operation mode after the first operation information is obtained.
a first obtaining unit, configured to obtain, after the start time point, a plurality of pieces of operation information of the user for the first virtual object during the running of the round of the cloud game; and
a second obtaining unit, configured to determine the second operation information based on the plurality of pieces of operation information.

The second obtaining unit may include:
a first determining module, configured to determine, from the plurality of pieces of operation information, first target operation information of which an information similarity with key operation information is higher than or equal to a first preset threshold; and
a second determining module, configured to determine the first target operation information as the second operation information when a quantity of pieces of the first target operation information is greater than or equal to a second preset threshold.

The second obtaining unit further may include:
a first input module, configured to input the plurality of pieces of operation information into a target model, the target model being a neural network model configured to recognize operation information of the user for the first virtual object obtained through training by using a plurality of pieces of sample operation information;
a second obtaining module, configured to obtain second target operation information outputted by the target model; and
a third determining module, configured to determine the second target operation information as the second operation information when the second target operation information is different from the first operation information.

The apparatus further may include:
a fourth determining module, including a first obtaining submodule, a first input submodule, a first determining submodule, and a second determining submodule, and configured to perform, before the inputting the plurality of pieces of operation information into a target model, the following operations until the target model is obtained.

The first obtaining submodule may be configured to obtain a current sample from the plurality of pieces of sample operation information, each sample operation information including a current environment parameter, a current action parameter, and a current sample result, the current environment parameter being a parameter related to an environment in which an operation corresponding to the sample operation information is performed, the current action parameter being an action type corresponding to the operation corresponding to the sample operation information, and the current sample result being information that corresponds to an operation performed by the second virtual object and matches the operation corresponding to the sample operation information.

The first input submodule may be configured to input the current sample into an intermediate model, to obtain intermediate operation information outputted by the intermediate model, the intermediate model being a model when the training of the neural network model is not completed.

The first determining submodule may be configured to determine, when an information similarity between the intermediate operation information and the current sample result is higher than or equal to a third preset threshold, that the intermediate model reaches a convergence condition, and determine the intermediate model as the target model.

The second determining submodule may be configured to determine, when the information similarity between the intermediate operation information and the current sample result is lower than the third preset threshold, that the intermediate model does not reach the convergence condition, obtain a next sample from the plurality of pieces of sample operation information, and determine the next sample as a current sample.

The apparatus further may include:
a first recognition module, that may be configured to perform, when the operation information is image information acquired during the running of the round of the cloud game, image recognition on the image information by using an image information recognition module in the target model after the inputting the plurality of pieces of operation information into a target model, to obtain processed operation information; and
a second input model, that may be configured to input the processed operation information into an operation information recognition module in the target model, to obtain the second target operation information.

The first determining unit 1104 may include:
a third obtaining module, that may be configured to obtain the first operation information generated by the user for the first virtual object in a first time period during the running of the round of the cloud game, determine the first operation mode based on the first operation information, and control an action operation of the second virtual object after the first time period based on the first operation mode.

The apparatus further may include:
a fourth obtaining module, that may be configured to obtain, after the controlling an action operation of the second virtual object after the first time period based on the first operation mode, the second operation information generated by the user for the first virtual object in a second time period after the first time period during the running of the round of the cloud game, determine the second operation mode based on the second operation information, and control an action operation of the second virtual object after the second time period based on the second operation mode.

The first determining unit 1104 may include a first control module, configured to control the second virtual object to execute at least one first operation instruction corresponding to the first operation mode; and
the first adjustment unit 1106 may include a second control module, that may be configured to control the second virtual object to execute at least one second operation instruction corresponding to the second operation mode.

For a additional details of the method implemented by the apparatus, refer to the foregoing one or more aspects of the method for controlling a virtual object.

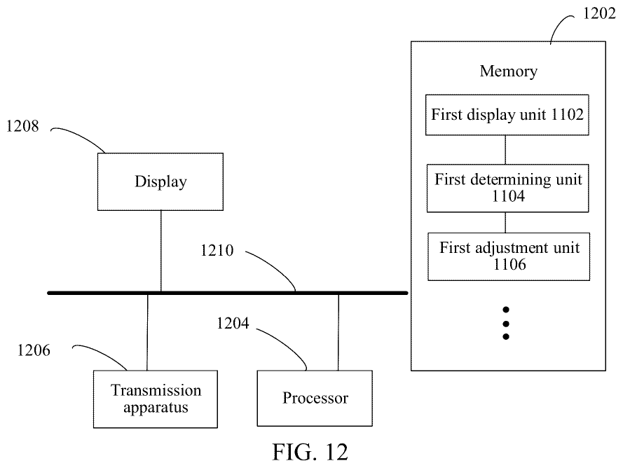

An electronic device for implementing the method for controlling a virtual object may be further provided. As shown in FIG. 12, the electronic device includes a memory 1202 and a processor 1204, the memory 1202 having a computer program stored therein, and the processor 1204 being configured to perform the operations in any one of the foregoing method one or more aspects by executing the computer program.

The foregoing electronic device may be located in at least one of a plurality of network devices in a computer network.

A person of ordinary skill in the art may understand that, a structure shown in FIG. 12 is merely an example. The electronic device may be a terminal device such as a smartphone (for example, an Android mobile phone and an iOS mobile phone), a tablet computer, a palmtop computer, a mobile Internet device (MID), and a PAD. FIG. 12 does not limit the structure of the foregoing electronic device. For example, the electronic device may further include more or less components (for example, a network interface) than those shown in FIG. 12, or have a configuration different from that shown in FIG. 12.

The memory 1202 may be configured to store a software program and a module, for example, program instructions/modules corresponding to the method and apparatus for controlling a virtual object in the one or more aspects of this application. The processor 1204 may the software program and the module stored in the memory 1202, to implement various functional applications and data processing, that is, implement the foregoing method for controlling a virtual object. The memory 1202 may include a high speed random access memory, or may include a non-volatile memory, such as one or more magnetic storage apparatuses, a flash memory, or another non-volatile solid-state memory. In some one or more aspects, the memory 1202 may further include memories remotely arranged relative to the processor 1204, and these remote memories may be connected to the terminal device through a network. Examples of the network include, but are not limited to, the Internet, an intranet, a local area network, a mobile communication network, and a combination thereof. The memory 1202 may be specifically configured to store information such as first operation information and second operation information, but is not limited thereto. In an example, as shown in FIG. 12, the memory 1202 may include, but is not limited to, the first display unit 1102, the first determining unit 1104, and the first adjustment unit 1106 in the foregoing apparatus for controlling a virtual object. In addition, the memory 1202 may further include, but is not limited to, another module unit in the foregoing apparatus for controlling a virtual object.

A transmission apparatus 1206 may be configured to receive or transmit data by using a network. Specific examples of the foregoing network include a wired network and a wireless network. In an example, the transmission apparatus 1206 may include a network interface controller (NIC). The NIC may be connected to another network device and a router by using a network cable, to communicate with the Internet or a local area network. In an example, the transmission apparatus 1206 may be a radio frequency (RF) module, to communicate with the Internet in a wireless manner.

In addition, the electronic device may further include: a display 1208, configured to display the first operation information, the second operation information, and/or the like; and a connection bus 1210, to connect to each module component in the electronic device.

The terminal device or a server may be a node in a distributed system, wherein the distributed system may be a blockchain system, and the blockchain system may be a distributed system formed by connecting a plurality of nodes in a form of network communication. A peer-to-peer (P2P for short) network may be formed between the nodes, and any form of computing device, such as a server or a terminal device, may be used as a node in the blockchain system by adding the peer-to-peer network.

A computer system of the electronic device is merely an example, and does not constitute any limitation on functions and use ranges of the one or more aspects of this application.

One or more processes described herein may be implemented as a computer software program. For example, a computer program product, including a computer program and/or instructions carried on a computer-readable medium may include program code configured to perform the method shown in the flowchart. The computer program may be downloaded and installed from a network through a communication portion, and/or installed from a removable medium. When the computer program is executed by a central processing unit, the various functions defined in the system of this application are executed.

A computer-readable storage medium configured to store computer instructions may further be provided. A processor of a computer device reads the computer instructions from the computer-readable storage medium, and executes the computer instructions, to enable the computer device to perform the method provided in the foregoing implementations.

A person of ordinary skill in the art may understand that, all or some of the operations of the methods in the foregoing one or more aspects may be implemented by a program instructing relevant hardware of a terminal device. The program may be stored in the computer-readable storage medium. The storage medium may include a flash disk, a read-only memory (ROM), a random access memory (RAM), a magnetic disk, an optical disk, and the like.

The sequence numbers of the foregoing one or more aspects of this application are merely for description purpose, but do not imply the preference among the one or more aspects.

When the integrated unit in the foregoing one or more aspects is implemented in a form of a software functional unit and sold or used as an independent product, the integrated unit may be stored in the foregoing computer-readable storage medium. Based on such an understanding, the technical solutions of this application essentially, or the part contributing to the related art, or all or some of the technical solutions may be presented in the form of a software product. The computer software product is stored in the storage medium and includes a plurality of instructions for instructing one or more computer devices (which may be a personal computer, a server, a network device, or the like) to perform all or some of operations of the methods in the one or more aspects of this application.

In the foregoing one or more aspects of this application, the descriptions of the one or more aspects may have different focuses.

In the one or more aspects provided in this application, the disclosed client may be implemented in another manner. The foregoing described apparatus are merely examples. For example, unit division is merely logical function division, and there may be other division manners in actual implementations. For example, a plurality of units or components may be combined or integrated into another system, or some features may be omitted or not performed. In addition, the coupling, or direct coupling, or communication connection between the displayed or discussed components may be the indirect coupling or communication connection through some interfaces, units, or modules, and may be electrical or of other forms.

Units described as separate components may or may not be physically separate, and components displayed as units may or may not be physical units, that is, may be located in one position, or may be distributed on a plurality of network units. Some or all of the units may be selected according to actual needs to achieve the objectives of the solutions of the one or more aspects described herein.

In addition, functional units in the one or more aspects described herein may be integrated into one processing unit, or each of the units may be physically separated, or two or more units are integrated into one unit. The integrated unit may be implemented in a form of hardware, or may be implemented in a form of a software function unit.

The foregoing descriptions are merely a part of implementations of this application, and a person of ordinary skill in the art may make various improvements and modifications without departing from the principle of this application. All such improvements and modifications shall fall within the protection scope of this application.

What is claimed is:

1. A method comprising:
causing to be displayed, by a terminal device and during running of a game on a cloud server, a first virtual object of the game and a second virtual object of the game, the first virtual object being controlled by a user of the terminal device, and the second virtual object being controlled by artificial intelligence;
obtaining first operation information generated by the user for the first virtual object during the running of the game on the cloud server;
determining a first operation mode corresponding to the second virtual object based on the first operation information;
controlling the second virtual object based on the first operation mode;
obtaining second operation information generated by the user for the first virtual object during the running of the game on the cloud server, the first operation information being different from the second operation information;
determining a second operation mode corresponding to the second virtual object based on the second operation information, the first operation mode being different from the second operation mode; and
adjusting, the first operation mode corresponding to the second virtual object to the second operation mode.

2. The method according to claim 1, wherein after the obtaining first operation information, the method further comprises:
determining a start time point of the first operation mode;
obtaining, after the start time point, a plurality of pieces of operation information of the user for the first virtual object during the running of the game on the cloud server; and
determining the second operation information based on the plurality of pieces of operation information.

3. The method according to claim 2, wherein the determining the second operation information based on the plurality of pieces of operation information comprises:
determining, from the plurality of pieces of operation information, first target operation information of which an information similarity with key operation information is higher than or equal to a first preset threshold; and
determining the first target operation information as the second operation information when a quantity of pieces of the first target operation information is greater than or equal to a second preset threshold.

4. The method according to claim 2, wherein the determining the second operation information based on the plurality of pieces of operation information comprises:
inputting the plurality of pieces of operation information into a target model, the target model being a neural network model that recognizes operation information of the user for the first virtual object obtained through training by using a plurality of pieces of sample operation information;
obtaining second target operation information outputted by the target model; and
determining the second target operation information as the second operation information when the second target operation information is different from the first operation information.

5. The method according to claim 4, wherein before the inputting the plurality of pieces of operation information into a target model, the method comprises:
obtaining a current sample from the plurality of pieces of sample operation information, each sample operation information comprising a current environment parameter, a current action parameter, and a current sample result, the current environment parameter being a parameter related to an environment in which an operation corresponding to the sample operation information is performed, the current action parameter being an action type corresponding to the operation corresponding to the sample operation information, and the current sample result being information that corresponds to an operation performed by the second virtual object and matches the operation corresponding to the sample operation information;
inputting the current sample into an intermediate model, to obtain intermediate operation information outputted by the intermediate model, the intermediate model being a model when the training of the neural network model is not completed;
determining, when an information similarity between the intermediate operation information and the current sample result is higher than or equal to a third preset threshold, that the intermediate model reaches a convergence condition, and determining the intermediate model as the target model; and
determining, when the information similarity between the intermediate operation information and the current sample result is lower than the third preset threshold, that the intermediate model does not reach the convergence condition, obtaining a next sample from the plurality of pieces of sample operation information, and determining the next sample as a current sample.

6. The method according to claim 4, wherein after the inputting the plurality of pieces of operation information into a target model, the method further comprises:
performing, when the operation information is image information acquired during the running of the game on the cloud server, image recognition on the image information by using an image information recognition module in the target model, to obtain processed operation information; and
inputting the processed operation information into an operation information recognition module in the target model, to obtain the second target operation information.

7. The method according to claim 1, wherein the obtaining first operation information generated by the user for the first virtual object during the running of the game on the cloud server, determining a first operation mode corresponding to the second virtual object based on the first operation information, and controlling the second virtual object based on the first operation mode comprises:
obtaining the first operation information generated by the user for the first virtual object in a first time period during the running of the game on the cloud server;
determining the first operation mode based on the first operation information; and
controlling an action operation of the second virtual object after the first time period based on the first operation mode.

8. The method according to claim 7, wherein after the controlling an action operation of the second virtual object after the first time period based on the first operation mode, the method further comprises:
obtaining the second operation information generated by the user for the first virtual object in a second time period after the first time period during the running of the game on the cloud server;
determining the second operation mode based on the second operation information; and
controlling an action operation of the second virtual object after the second time period based on the second operation mode.

9. The method according to claim 1, wherein:
the controlling the second virtual object based on the first operation mode comprises: controlling the second virtual object to execute at least one first operation instruction corresponding to the first operation mode; and
the controlling the second virtual object based on the second operation mode comprises: controlling the second virtual object to execute at least one second operation instruction corresponding to the second operation mode.

10. An apparatus comprising:
one or more processors;
memory storing instructions that when executed by the one or more processors, cause the apparatus to:
cause to be displayed, during running of a game on a cloud server, a first virtual object of the game and a second virtual object of the game, the first virtual object being controlled by a user, and the second virtual object being controlled by artificial intelligence;
obtain first operation information generated by the user for the first virtual object during the running of the game on the cloud server;
determine a first operation mode corresponding to the second virtual object based on the first operation information;
control the second virtual object based on the first operation mode;
obtain second operation information generated by the user for the first virtual object during the running of the game on the cloud server, the first operation information being different from the second operation information;
determine a second operation mode corresponding to the second virtual object based on the second operation information, the first operation mode being different from the second operation mode; and
adjust, the first operation mode corresponding to the second virtual object to the second operation mode.

11. The apparatus according to claim 10, the memory storing instructions that when executed by the one or more processors further cause the apparatus to, after the obtaining first operation information:
determine a start time point of the first operation mode;
obtain, after the start time point, a plurality of pieces of operation information of the user for the first virtual object during the running of the game on the cloud server; and
determine the second operation information based on the plurality of pieces of operation information.

12. The apparatus according to claim 11, wherein the determining the second operation information based on the plurality of pieces of operation information comprises:
determining, from the plurality of pieces of operation information, first target operation information of which an information similarity with key operation information is higher than or equal to a first preset threshold; and
determining the first target operation information as the second operation information when a quantity of pieces of the first target operation information is greater than or equal to a second preset threshold.

13. The apparatus according to claim 11, wherein the determining the second operation information based on the plurality of pieces of operation information comprises:
inputting the plurality of pieces of operation information into a target model, the target model being a neural network model that recognizes operation information of the user for the first virtual object obtained through training by using a plurality of pieces of sample operation information;
obtaining second target operation information outputted by the target model; and
determining the second target operation information as the second operation information when the second target operation information is different from the first operation information.

14. The apparatus according to claim 13, the memory storing instructions that when executed by the one or more processors further cause the apparatus to, before the inputting the plurality of pieces of operation information into a target model:
obtain a current sample from the plurality of pieces of sample operation information, each sample operation information comprising a current environment parameter, a current action parameter, and a current sample result, the current environment parameter being a parameter related to an environment in which an operation corresponding to the sample operation information is performed, the current action parameter being an action type corresponding to the operation corresponding to the sample operation information, and the current sample result being information that corresponds to an operation performed by the second virtual object and matches the operation corresponding to the sample operation information;
input the current sample into an intermediate model, to obtain intermediate operation information outputted by the intermediate model, the intermediate model being a model when the training of the neural network model is not completed;
determine, when an information similarity between the intermediate operation information and the current sample result is higher than or equal to a third preset threshold, that the intermediate model reaches a convergence condition, and determining the intermediate model as the target model; and
determine, when the information similarity between the intermediate operation information and the current sample result is lower than the third preset threshold, that the intermediate model does not reach the convergence condition, obtaining a next sample from the plurality of pieces of sample operation information, and determining the next sample as a current sample.

15. The apparatus according to claim 13, the memory storing instructions that when executed by the one or more processors further cause the apparatus to, after the inputting the plurality of pieces of operation information into a target model:
perform, when the operation information is image information acquired during the running of the game on the cloud server, image recognition on the image information by using an image information recognition module in the target model, to obtain processed operation information; and
inputting the processed operation information into an operation information recognition module in the target model, to obtain the second target operation information.

16. A non-transitory computer-readable storage medium comprising instructions that when executed by one or more processors, cause the one or more processors to:
cause to be displayed, during running of a game on a cloud server, a first virtual object of the game and a second virtual object of the game, the first virtual object being controlled by a user, and the second virtual object being controlled by artificial intelligence;
obtain first operation information generated by the user for the first virtual object during the running of the game on the cloud server;
determine a first operation mode corresponding to the second virtual object based on the first operation information;
control the second virtual object based on the first operation mode;
obtain second operation information generated by the user for the first virtual object during the running of the game on the cloud server, the first operation information being different from the second operation information;
determine a second operation mode corresponding to the second virtual object based on the second operation information, the first operation mode being different from the second operation mode; and
adjust, the first operation mode corresponding to the second virtual object to the second operation mode.

17. The transitory computer-readable storage medium according to claim 16, storing instructions that when executed by the one or more processors further cause the one or more processors to, after the obtaining first operation information:
determine a start time point of the first operation mode;
obtain, after the start time point, a plurality of pieces of operation information of the user for the first virtual object during the running of the game on the cloud server; and
determine the second operation information based on the plurality of pieces of operation information.

18. The transitory computer-readable storage medium according to claim 17, wherein the determining the second operation information based on the plurality of pieces of operation information comprises:
determining, from the plurality of pieces of operation information, first target operation information of which an information similarity with key operation information is higher than or equal to a first preset threshold; and
determining the first target operation information as the second operation information when a quantity of pieces of the first target operation information is greater than or equal to a second preset threshold.

19. The transitory computer-readable storage medium according to claim 17, wherein the determining the second operation information based on the plurality of pieces of operation information comprises:
inputting the plurality of pieces of operation information into a target model, the target model being a neural network model that recognizes operation information of the user for the first virtual object obtained through training by using a plurality of pieces of sample operation information;
obtaining second target operation information outputted by the target model; and
determining the second target operation information as the second operation information when the second target operation information is different from the first operation information.

20. The transitory computer-readable storage medium according to claim 19, storing instructions that when executed by the one or more processors further cause the one or more processors to, before the inputting the plurality of pieces of operation information into a target model:
obtain a current sample from the plurality of pieces of sample operation information, each sample operation information comprising a current environment parameter, a current action parameter, and a current sample result, the current environment parameter being a parameter related to an environment in which an operation corresponding to the sample operation information is performed, the current action parameter being an action type corresponding to the operation corresponding to the sample operation information, and the current sample result being information that corresponds to an operation performed by the second virtual object and matches the operation corresponding to the sample operation information;
input the current sample into an intermediate model, to obtain intermediate operation information outputted by the intermediate model, the intermediate model being a model when the training of the neural network model is not completed;
determine, when an information similarity between the intermediate operation information and the current sample result is higher than or equal to a third preset threshold, that the intermediate model reaches a convergence condition, and determining the intermediate model as the target model; and
determine, when the information similarity between the intermediate operation information and the current sample result is lower than the third preset threshold, that the intermediate model does not reach the convergence condition, obtaining a next sample from the plurality of pieces of sample operation information, and determining the next sample as a current sample.
